(19) United States
(12) Patent Application Publication
(10) Pub. No.: US 2003/0018493 A1
(43) Pub. Date: Jan. 23, 2003

(54) Commercial transaction management system and method for same

(75) Inventor: Kazuo Takemoto, Hachioji-shi (JP)

Correspondence Address: MATTINGLY, STANGER & MALUR, P.C., 1800 DIAGONAL ROAD, SUITE 370, ALEXANDRIA, VA, 22314, US

(73) Assignee: Hitachi, Ltd.

(21) Appl. No.: 10/246,630

(22) Filed: Sep. 19, 2002

Related U.S. Application Data
(63) Continuation of application No. 09/440,466, filed on Nov. 15, 1999.

(30) Foreign Application Priority Data
Nov. 16, 1998 (JP) 10-325166

(51) Int. Cl. G06F 17/60

(52) U.S. Cl. 705/1

(57) ABSTRACT

A commercial transaction management system using EDI in which office work in transaction between enterprises is electronized, wherein EDI data exchanged by the EDI between the one-on-one parties who do commercial transaction is down-loaded to database in a server for the purpose of commercial transaction. The server is arranged in the intermediate position between a plurality of parties for conducting commercial transactions and predetermined data are extracted from EDI data so as to build a relational database. Extracted are management information relating to commercial transactions such as unfair order, order in balance, time of delivery, inventory in hand, amount of accounts payable, and amount of accounts receivable. A person having predetermined authority can make access to database.

### BACKGROUND OF THE INVENTION

The present invention relates to a commercial transaction management system for smoothly managing commercial transaction in which at least three users (such as enterprises, legal persons, etc.) involve in a single business, and more particularly to a commercial transaction management system capable of improving various management such as management for acceptance and ordering of an order, management for the time of delivery management, inventory management, accounts payable management, and accounts receivable management.

It is said generally that in the production form of manufacturing fields in Japan, to make production concentrate as much as possible leads to more efficient production. The reason why is that since within Japan, a difference in economic infrastructure (such as personnel expenses, traffic facilities, communication facilities, etc.) according to regions is small, it is an important point to minimize the distribution cost in parts procurement, production process, and the like.

However, all sorts of the industries have found a larger market abroad due to the rise of production cost including personnel expenses. At present, international division of work having merits of respective countries and respective regions combined has been performed while dispersing risks provided with a plurality of choices without being limited to the productions in specific countries and regions on the basis of various factors such as circumstances of economic infrastructure, level of production cost or the like in mating countries.

When a scale of transaction with overseas is enlarged, and the necessity with respect to variety and rapidness of the transaction forms increases, a problem in terms of efficiency occurs in office work of traditional international transactions such as TELEX, mailing or the like as in prior art. Thus, there has been used EDI (Electronic Data Interchange) in which office work in transaction between these enterprises is electronized.

In a conventional EDI system, an orderer and a receiver apply to an EDI provider concerned to enter for the EDI provider. The EDI provider concerned provides a mechanism for exchanging a message of commercial transaction on the one-on-one basis between the orderer and receiver.

For example, when the orderer wishes to order the receiver predetermined parts or the like, an order sheet of electronic data is transmitted as a message addressed to the receiver from the system of the orderer. The server of the EDI provider who has received the message recognizes that it is the message addressed to the receiver to store the message in a mail box of the receiver. The system of the receiver is connected to the server of the EDI provider to know that the message is stored in its own mail box to down-load the message. Since the message is an order sheet from the orderer, the receiver performs various actions according to the order sheet. For example, in the case where all the orders of the order sheet are accepted, a receipt of the orders is sent addressing to the orderer, and in the case not capable of accepting all the orders, a message indicative of the conditions is sent addressing to the orderer, or the interoffice management system makes a production plan in compliance with the order sheet.

Normally, the orderer and receiver are provided with their respective interoffice management systems which perform various interoffice management such as receiving and ordering management, the time of delivery management or the like. In the case where the aforementioned ordering and accepting are carried out, the data type expressing the ordering and accepting in each of the interoffice management systems is the independent type of each interoffice. On the other hand, the data type of a message to be transmitted and received between the orderer and receiver through the EDI provider should be a common type that can be recognized by both systems of the orderer and receiver. Hence, a predetermined interface is provided between each interoffice management system and an EDI provider so that a format exchange is made between a data format in each interoffice and a data format in the EDI provider.

The present EDI being used for transaction between enterprises fundamentally remains in a region in which relative papers such as an order sheet that have been heretofore used for transactions are electronized. That is, a respective seller and a respective buyer exchange a message of EDI in a one-on-one relation, and it is a mere change in medium called “Paper is replaced with data”. Of course, if exchange is made by data in place of paper, this data can be utilized directly for an order accepting system or a production management system so that it is not necessary for the parties of ordering and accepting an order to manually input information entered paper into its own office system. However, in the stage of building a work-division system between regions and between internationals, the commercial transaction takes the form in which they are related one another systematically to a plurality (3 points or more) of parties or relevant points. Therefore, sufficient management cannot be made by a mechanism of electronic commercial transaction in which a seller and a buyer are linked in one-on-one basis as in the present EDI.

Assume now that for example, a company X gives respective company AA, company BB, and company CC in three different regions an order of the product composed of three blocks A, B, and C corresponding to levels of difficulty (difficulty of manufacturing the blocks). If a problem should occur in the process of manufacturing the block A, this problem also influences on the production of the blocks B and C. Specifically, there generates the necessity for finely controlling the production plan of the blocks B and C, the parts procuring situation, the contents of inventory and the like on the basis of the problem situation of the block A. If this is neglected, inventory for a long period occurs, and a problem in deterioration of a cash flow occurs. For example, in the case where a trouble occurs in the factory of the company AA to fail to produce the block A, the blocks B and C are fed in succession to the company X from the company BB and the company CC continuously unless notified so as to stop the production of the blocks B and C in the company BB and the company CC. Accordingly, in the company X, inventory of the blocks B and C increases, and also, despite the fact that the final products cannot be produced because the blocks A are not delivered, the amount of payment to the company BB and the company CC increases.

In such a case as described above, in the conventional EDI, the production plan of the blocks B and C, the parts procuring situation, the contents of inventory and the like are controlled, for example, in the following procedure: \mathring{1} The company AA notifies the company X of a delay of production of the product A. \mathring{2} The company X confirms the situation of inventory of the blocks B and C, and the parts procuring situation. \mathring{3} The company X presents the company AA an alternative proposal on the basis of information from the company CC. \mathring{4} The company X instructs the companies BB and CC proposed measures on the basis of the alternative proposal of the company AA.

The aforementioned problems of exchange lie in the following two points: \mathring{1} The exchange of information by the EDI consists of the one-on-one communication of transmission and reception, and \mathring{2} The object for managing a day's schedule of products to be shared is dispersed into points (the companies AA, BB and CC) in charge of the respective blocks.

That is, the conventional EDI takes the form such that the management for completing a single final product is dispersed into different systems such as a plurality of legal persons, which are mediated in one-on-one through a message of EDI. Because of this, the process of instructions and responses is repeated many times between a plurality of parties, which is not effective, and has no assurance that information exchanged is accurate. Further, as the case may be, there also occurs a problem of incoincidence of information due to a difference in time of a point in time for instructions and responses to possibly bring forth confusion between the parties.

### SUMMARY OF THE INVENTION

In view of the aforementioned problems with respect to prior art, an object of the present invention is to provide a commercial transaction management system for smoothly managing commercial transaction in which at least three users (such as enterprises, legal persons, etc.) involve in a single business, wherein even if a problem should occurs in a certain user, the system is able to cope with the problem efficiently and smoothly without bringing forth confusion as the entire business.

For achieving the aforesaid object, the present invention provides a commercial transaction management system using EDI (Electronic Data Interchange) in which office work in transaction between enterprises is electronized, characterized in that EDI data exchanged by the EDI between one-on-one parties who do commercial transaction is down-loaded to database in a server for the purpose of commercial transaction.

Further, the present invention is characterized in that management information relating to commercial transaction is taken out of the EDI, and relational database is built up every classifications. The management information relating to commercial transaction are information relating to, for example, unfair order, order in hand, time of delivery, inventory in hand, amount of accounts payable, amount of accounts receivable, etc.

Still further the present invention is characterized in that data retrieved under predetermined conditions are taken out of the database, and various management reports relating to commercial transaction between the parties are prepared from the taken-out data.

Still further the present invention is characterized in that the management reports are stored on the server, and a person having predetermined authority is allowed to refer to the management reports.

Still further the present invention is characterized in that the database on the server and the contents of the management reports are updated to real time in association with the EDI data of commercial transaction originated at real time.

Still further the present invention is characterized by further comprising means to account a person who makes access to the management reports.

Still further the present invention provides a transaction management system using EDI in which office work in transaction between parties is electronized, comprising: means for exchanging EDI data for doing one-on-one transaction between suitable one set of parties out of a plurality of parties entered for the EDI; means for extracting management information relating to predetermined commercial transaction from the EDI data in the midst of transmitting and receiving the EDI data exchanged on one-on-one basis to register it in database; and means for allowing a person to whom is allowed predetermined access authority out of the plurality of parties to make access to the database.

As described above, according to the present invention, predetermined information is taken out, in the midst of exchange, from EDI data exchanged between the parties in one-on-one relation to build a database. For example, a trading company performs OEM (original equipment manufacturing) business in an international division of work, efficiency of the trading transaction created in relation to the business can be provided. Specifically, even in the case where material makers have trouble in the product fabricating system of stratum construction as explained in connection with FIG. 2, the product assembly enterprise at top rank can make access to a common database to know information relating the material makers rapidly and accurately, thus enabling efficient and smooth response without bringing forth confusion as the entire business. Further, since management reports are prepared from EDI data, a new input is not necessary. Further, since even parties who are not direct parties of transaction are possible to hold information in common, transactions to which many points are related, or concentrated control from the head office mechanism are possible. Since an application is on the server side, there are following effects: \mathring{1} Maintenance is easy, and standardization can be provided efficiently (maintenance of system on the client side is easy); \mathring{2} Transaction with outeroffice can be finely managed without provision of sufficient system on the user side; \mathring{3} Change of customer is relatively easy (not depending on the system of customer); \mathring{4} Even commercial transactions between different businesses different from production system and business system can set a high degree of management system adapted to the business on the basis of the common server; and \mathring{5} Since commercial transaction data are concentrated on one spot, data can be provided to relevant businesses such as banks and physical distribution into a variety of improvements.

### BRIEF DESCRIPTION OF THE DRAWINGS

FIG. 1 is a system conceptual view of an embodiment according to the present invention.

FIG. 2 is a systematic view in fabricating products.

FIG. 3 is a view showing a relationship between a finished product model and parts constituting it.

FIG. 4 is a conceptual view of joint ownership of information in the system according to the present embodiment.

FIG. 5 is a conceptual view of the system according to the present embodiment.

FIG. 6 is a flowchart showing the procedure for registering received EDI data in a common database.

FIG. 7 is a view showing examples of items of EDI data to be classified and extracted.

FIG. 8 is a view showing items of data for registration from which only necessary items are extracted.

FIG. 9 is a view showing items of data for registration into the database.

FIG. 10 is a view showing the construction of a common database.

FIG. 11 is a view showing a specification example of classification flags of EDI data.

FIG. 12 is a flowchart showing the procedure in which a use makes access to a common database.

FIG. 13 is a view showing an example of a limiting table of user access.

FIG. 14 is a process conceptual view of queries.

FIG. 15 is a view showing an example of a query report regarding the order placing management.

FIG. 16 is a view showing an example of a query report regarding the delivery management.

FIG. 17 is a view showing an example of a query report regarding the payment management.

FIG. 18 is a view showing an example of a query report regarding the fund management.

FIG. 19 is a view showing the process procedure for maintenance of the common database.

### DESCRIPTION OF THE EMBODIMENTS

The embodiments of the present invention will be explained hereinafter with reference to the drawings.

Generally, the contents of information transmitted by EDI can be largely divided into two kinds as follows.

(1) Information relating to the procedure for commercial transaction, and

(2) Information relating to the management of commercial transaction.

The conventional EDI can be grasped in the form in which the aforementioned two kinds of information circulate through the parties in one-on-one in a mixed manner. On the other hand, in the present invention, the information relating to the procedure for commercial transaction is managed merely by the one-on-one parties as in prior art, and the information relating to the management of commercial transaction is managed while holding in common information between the related users at real time concentrating on the server located in the middle between the transactors. Information with outside relating to commercial transaction is not individually managed using an internal system of an interoffice owned by each user, but is managed in the form of holding in common information while being referred to by the related users concentrating on one place (server). Therefore, it is effective that information relating to various information such as production management (information relating to management of commercial transaction) is discriminated from normal EDI information (information relating to the procedure for commercial transaction), and a separate system on the assumption of concentration of information is prepared in the midst of commercial transaction.

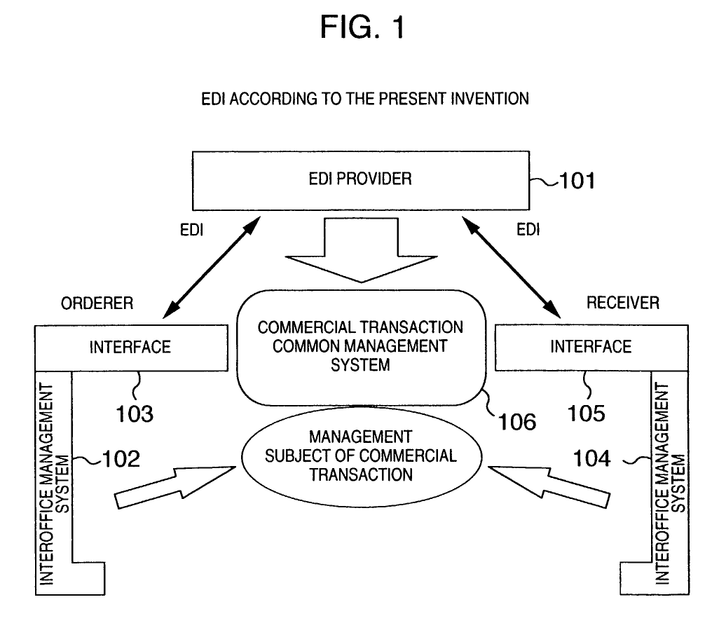

FIG. 1 shows the outline of the system according to the embodiment of the present invention. Reference numeral 101 designates a server of an EDI provider; 102 an interoffice management system of an orderer; 103 an interface between the interoffice management system 103 of an orderer and the server 101 of an EDI provider; 104 an interoffice management system of an order receiver; and 105 an interface between the interoffice management system 104 of an order receiver and the server 101 of an EDI provider. There is shown here paying attention to the case where a single orderer and a single order receiver perform commercial transaction. However, in manufacturing one product, various makers such as a maker for finally assembling the product, a maker for manufacturing a model to be parts used for the final assembly, a maker for manufacturing parts for the model, a maker for manufacturing material constituting the parts and the like are participated as will be described later. Therefore, all these makers enter for the EDI provider shown in FIG. 1, and the commercial transaction between these makers is performed in EDI as shown in FIG. 1.

The server 101 of an EDI provider stores EDI data for commercial transaction exchanged in the post office function and to use it to provide the respective parties of commercial transaction management data relating to the transaction state. More specifically, the server 101 of an EDI provider stores EDI message intermediated, a commercial transaction common management system 106 processes and arranges data of the EDI message, and users can be referred to via Internet and an extra net. In this case, the object of the commercial transaction management is not the conventional orderer and order receiver but the commercial transaction common management system 106 actually provided.

The processing flow of the system shown in FIG. 1 is as described below.

(1) The server 101 of an EDI provider (the commercial transaction common management system 106 is actually provided) placed in an intermediate point of transaction extracts data that can be utilized for transaction management such as production, fund, inventory and the like from the EDI message of commercial transaction transmitted from the orderer by identifying a flag and stores the extracted information. Which data is extracted and stored from the EDI message is predetermined under the understanding of a customer, and a predetermined flag is put up on the date in the EDI message. As a pre-preparation, an enterprise for providing an EDI provider's service is necessary to make a wide EDI service network through new installation of points in various areas, an agreement of VAN to VAN, a business tie-up and the like. Further, EDI is made to start among the point of a customer, a customer, and a customer on business. A place for concentrated management of information is predetermined according to the form of business, and the server 101 for performing commercial transaction management are installed in advance.

(2) The server prepares relational database on the basis of stored information.

(3) Further, in the server is prepared a management sheet relating to placing and accepting an order, production management and the like on the basis of the database. In preparing the management sheet, a query function such as SQL may be utilized.

(4) The EDI message exchanged in the post office function is always subjected to processing as noted in the above flows (1) to (3) whereby data of the management sheet is successively updated on the server on the basis of the latest data of EDI.

(5) A limitation function is added to information disclosed according to a degree of participation for the parties relating to the project, the products and the like. In summary, to whom which data is allowed for access is predetermined, and its authority is registered in the server.

(6) The related parties make access to the server via the Internet or the extranet, and the related information is referred to by the management sheet according to the authority thereof. The enterprise of the EDI provider accounts linking to utilization by a customer.

The system according to the present invention as shown in FIG. 1 is largely different from the conventional EDI in that the management of commercial transaction that has been so far carried out in the interoffice system by the respective parties is carried out making use of EDI data on the server of the EDI provider which is the intermediate point of transaction. Accordingly, the order placing and accepting management system as the interoffice system owned by the parties is of no longer importance as the commercial transaction management. The commercial transaction comprises the exchange of information with the outeroffice, and the management by separate systems of a seller and a buyer is that complicated and rapid management is unnatural due to a difference in management procedure, synchronousness of data and the like. Rather, the management while holding in common information by the intermediate server after management items and business standards are defined by the parties is advantageous in building a seamless supply chain.

Note, there is a banking system or the like as a service which uses a conventional Internet technique, which also disclose users information concentrated on one point similar to the present invention. However, these systems are that in the form in which one party who holds a large amount of information provides a plurality of other parties information, and the information exchange between the parties is in the relation of “one-on-N” which comprises a plurality of “one-on-one” relations. Accordingly, this is the same as a plurality of relations of EDI in which information is exchanged in the conventional “one-on-one” relation. On the other hand, in the case where certain products are produced, there are respective stages of block assemblies, parts, and materials prior to final assembling work. Respective commercial transactions are present to link these stages. Accordingly, in components for making these products, the process leading to a fundamental material is related like a tree. Out of systems of commercial transaction having a tree construction as described above, the system of the present invention for collecting management information of commercial transactions to manage the entire production of products is different from the system which provides information in the “one-on-N” relation as described above. The system of commercial transaction of the tree construction employed by the system of the present invention will be explained hereinafter.

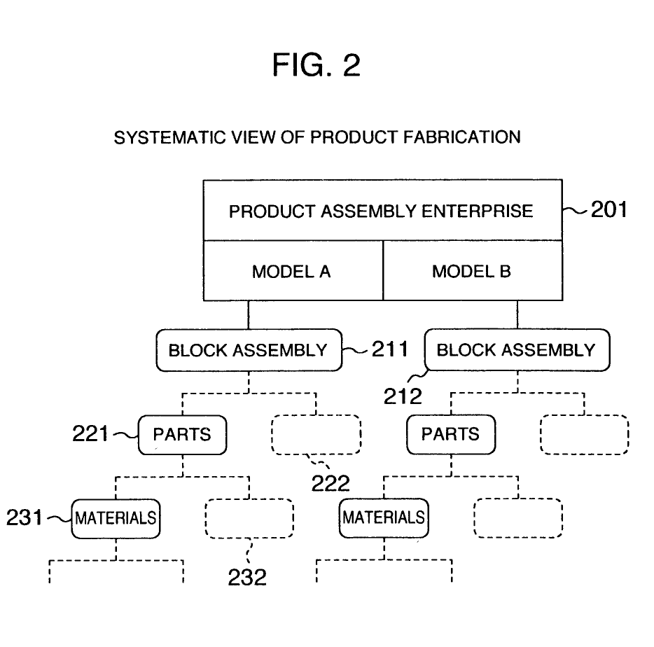

FIG. 2 shows a systematic view in fabricating a certain product. A product assembling enterprise 201 fabricate a certain product, and the product is fabricated by finally assembling using a model A and a model B. The product assembling enterprise 201 orders a maker 211 for assembling blocks the model A, and a maker 212 for assembling blocks the model B, respectively. The maker 211 for assembling blocks orders parts makers 221 or 222 parts for assembling the model A. A parts maker 221 orders material makers 231 or 232 materials necessary for manufacturing the parts. The same is true for the other parts maker 222. The material maker 231 orders a separate maker raw materials necessary for manufacturing the material. Likewise the model B, a plurality of manufacturing processes such as an assembly of blocks, a manufacture of parts, and a manufacture of materials form a stratum relation.

The respective stratums are linked by the act “Commercial transaction” between the enterprises. In FIG. 2, the solid line and the dotted line for connecting a high-ranking maker to a low-ranking maker represent respective commercial transactions. The commercial transactions as described are in the one-on-one relation. Accordingly, in the conventional EDI, the commercial transaction that can be managed by the product assembling enterprise 201 shown in FIG. 2 is only the commercial transaction (for example, order placing and accepting information) (indicated by the solid line in FIG. 2) between the makers 211 and 212 in charge of “Assembly of blocks”. With respect to the commercial transaction (indicated by the dotted line in FIG. 2) at a level of “Parts” and “Materials”, the product assembling enterprise 201 cannot manage them because they are not the parties of commercial transaction.

Accordingly, for example, even if the material maker 231 fails to provide materials due to the occurrence of trouble or the like, in the conventional EDI, the product assembling enterprise 201 cannot know it directly. The product assembling enterprise 201 is to know that the materials are not provided to impede a supply of the model A first in the procedures that the material maker 231 notifies the parts maker 221 in the one-on-one relation, the parts maker 221 notifies the block assembling maker 221 in the one-on-one relation, and the block assembling maker 211 notifies the product assembling enterprise 201 in the one-on-one relation. Accordingly, there is a problem in that the rapidness and reliance of information are low due to the fact that there is a time lag till the information is obtained, an that the information is generated in the material maker and brought about through the parts maker and the block assembling maker.

On the other hand, in the system according to the embodiment of the present invention shown in FIG. 1, information is held and managed at the intermediate point (such as the EDI provider) as previously mentioned. The respective makers 201, 211, 212, 221, 222, 231, 232, . . . shown in FIG. 2 enter for the EDI provider explained in connection with FIG. 1 to enable exchange of EDI messages through the server 101. This takes the form in which in the server 101 in an intermediate and neutral position, various data are extracted from the EDI messages of commercial transaction between the makers and stored to concentrate information. Thereby, even a person not in a position of the direct parties of commercial transaction in the one-on-one relation can have the management subject of commercial transaction.

For example, the product assembling enterprise 201 shown in FIG. 2 is not the party of commercial transaction of materials but can make access to management information of commercial transaction of materials, and can know rapidly and accurately that there is a problem in supplying material. This can realize an ideal SCM (Supply Chain Management) that has not been available. For example, a trading company having the head office in Japan can concentratedly manage the progress state of projects by the points that have been relied on periodical reports from the respective points, fund raising as the entire company and the like. Further, by doing so, even a person who is not the direct party of commercial transaction can make optimum management of interoffice inventory, employment of fund, production and the like while referring to related information.

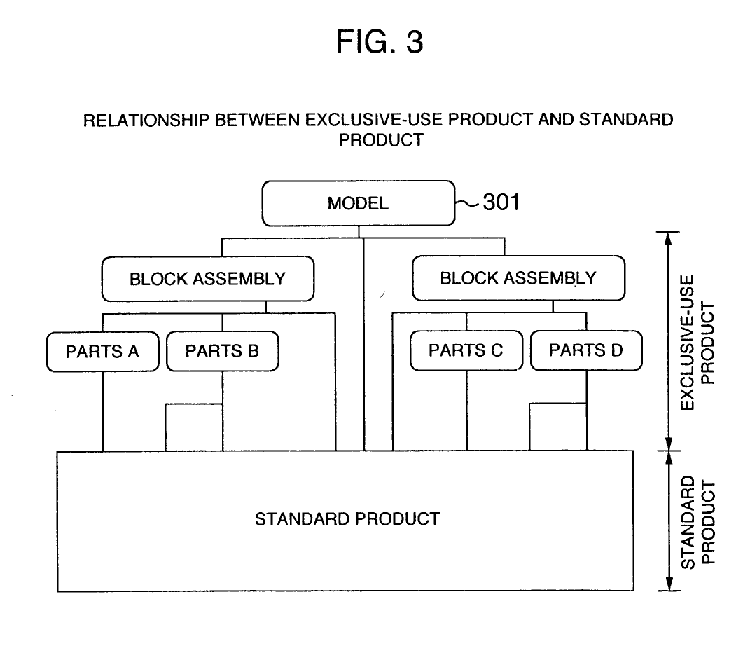

The range of an object of management in the system according to the embodiment of the present invention will be explained. FIG. 3 shows one example of a relationship between a model of a finished article and parts constituting it. The tree construction shows that one positioned at a high rank is made from one positioned at a low rank joined by a line. The parts constituting a model 301 of a finished article is divided into an exclusive-use article (parts that can be used merely for the corresponding model) and a standard article (articles in catalogue, and those that can be used for those other than the corresponding model and are available in the market as standard articles). Since the exclusive-use article corresponds to the production of the corresponding model in the one-on-one relation, the commercial transaction can be managed in the tree construction explained in connection with FIG. 2, but in the case of standard articles, such a management as described above cannot be made. A customer in charge of standard articles makes production while considering an optimum production lot or the like directed at other customers, and therefore this will not be production for which an order is accepted directed at the model. Accordingly, the standard article will not be an object for concentrated management of commercial transaction in the system according to this embodiment. Even if a problem in terms of supply occurs, the standard article can be generally replaced with a substitute which is easily procured, and therefore, management in the form related to the model is not necessary. On the other hand, in the exclusive-use article, since a procuring route is limited to one place, the occurrence of a problem would often lead to a fatal wound with respect to the entire production, and the management related to the model is necessary.

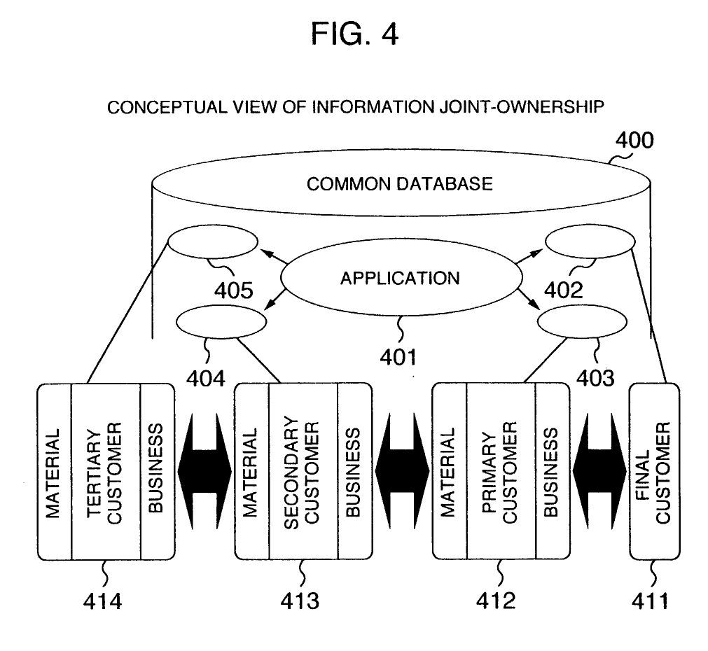

FIG. 4 is a conceptual view holding in common information in the system shown in FIG. 1. As viewed from the point of the commercial transaction, the stratum construction leading to the final produce explained in connection with FIG. 2 starts from the final customer, then connecting to a primary customer, a secondary customer and a tertiary customer to form a chain-like configuration. Such a chain-like construction as described is generally called a supply chain. In FIG. 4, a chain which connects, from a final customer (for example, the product assembling enterprise 201 in FIG. 2) 411, to a primary customer (for example, the block assembling maker 211 in FIG. 2) 412, a secondary customer (for example, the parts maker 221 in FIG. 2) 413 and a tertiary customer (for example, the material maker 231 in FIG. 2) 414 is a supply chain. The transaction of the supply chain is composed in a pair of the windows of “materials” and “business”, and the transmission of receiving and ordering an order and related information in the respective transactions as described is repeated whereby the supply chain is constituted. As the number of stratums, that is, supply chains increases, a problem occurs in the communication between left and right terminals from a viewpoint of correctness and rapidness of information. Further, since persons are involved in various forms, the cost increases.

In the present invention, the transaction state at the respective transaction stages of the supply chain is registered in a common database 400 positioned in the midway, which is related using an application 401. This application 401 defines that to what and in what a format a customer participated in a certain project refers with respect to information of the enterprise related to the project. The registration of the transaction state to the common database 400 is carried out by extracting predetermined information from the EDI messages exchanged between the makers and storing them as described in connection with FIG. 1. The information related to by the application 401 is referred to by making direct access to the common database 400 while the respective makers conform to the limitation. Thereby, even a person who is not a direct party of individual commercial transaction can refer to related information to hold information in common. Each transaction has a domain of transaction. The numerals 402-405 indicate the domains of transactions.

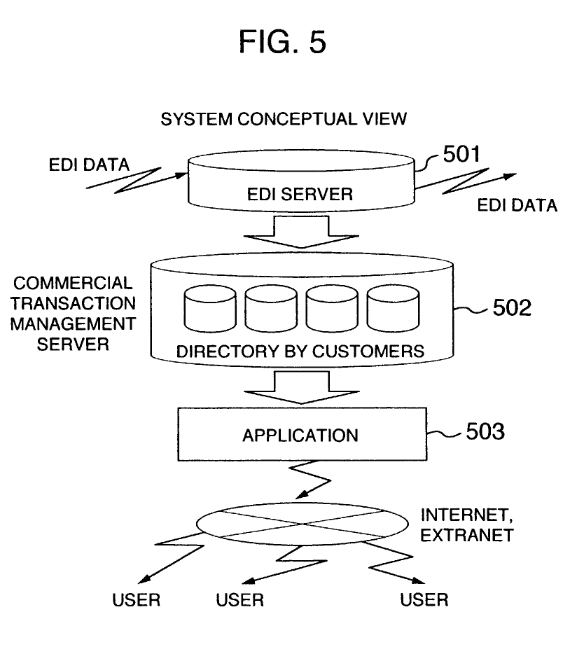

FIG. 5 is a conceptual view of the system according to the embodiment of the present invention, showing a mechanism in which predetermined information is extracted from an EDI message and registered in a common database, allowing each user (maker) to make access data of the common database through an application. In the figure, the EDI message (EDI data in the figure) passes through an EDI server 501 and is transmitted and received between the order placing side and the order receiving side. Data for which permission of a user is obtained in the EDI data (data on which a predetermined flag is put) and data to which the server 501 is addressed are down-loaded to a commercial transaction management server 502. The commercial transaction management server 502 is a server on which the commercial transaction common management system 106 of FIG. 1 is actually installed, and relational databases (common database 400 in FIG. 4) for businesses and customers are built. A commercial transaction management application (the application 401 in FIG. 4) 503 starts in response to a user's request to form various kinds of commercial transaction management reports. The user makes access to the server 502 via Internet or an extranet, and refers to necessary management data in conformity to the limited matter.

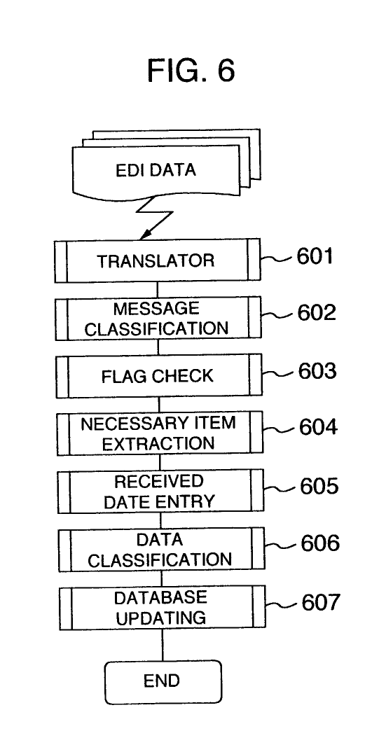

FIG. 6 is a flowchart showing the procedure for registering in a common database EDI data received in the server (101 in FIGS. 1 and 501 in FIG. 5) of an EDI provider. First, in Step 601, the received EDI data is converted in form from data format of EDI to flat format. In Step 602, the received EDI data are classified according to classification (classification for example, such as an order sheet, a time of delivery instruction, amount of accounts payable, amount of accounts receivable, an order in hand, a debit note, etc.). In Step 603, a classification flag is checked. When the classification flag is turned on, the EDI data is extracted as an object data to be registered in a common database. This classification flag is a flag to determine whether or not data is the object data to be registered in the common database, which is attached to the EDI data in advance. In Step 604, data of necessary item out of EDI data extracted as object data is extracted.

In Step 605, received date and time are entered in a designated position in data. In Step 606, data is classified. This retrieves if the same kind of data is received in the past and registered in the common database. If registered, what the sequence number of the present data is is entered in the designated position. If it is a new data, [001] is entered. Specifically, data of the same order number as that of EDI data received this time is retrieved from the common database to count what the sequence number of the received data is in the same order number. From this time of data, for example, it is possible to display so as to show that when referring to this data later, the data in question is a new data or has been changed. In Step 607, the data extracted and arranged in Steps 601 to 606 are registered in the common database, and the management is completed.

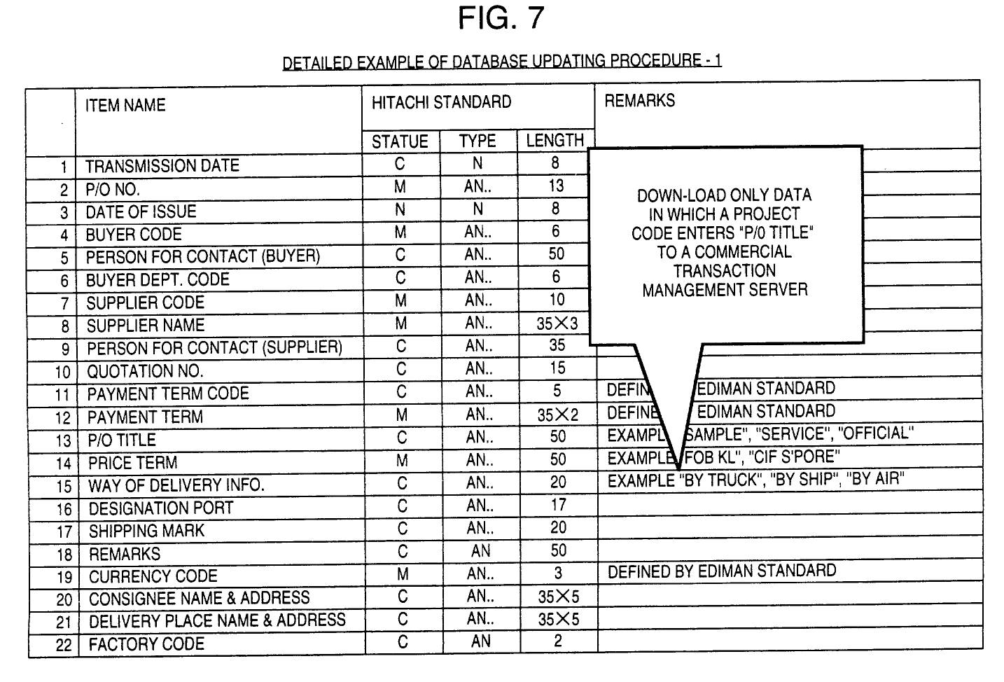

FIG. 7 shows an example of items of EDI data to be classified and extracted in Steps 602 and 603 of FIG. 6. Here, an example is given of EDI data of an order sheet. The code area for flag of data represented by “P/0 Title” indicated at 13 of item number on the left end in the figure is a classification flag indicative of whether it is object data to be extracted in Step 603. FIG. 7 shows that the length of the code area for flag is 50 bits. The data in which a project code is written in this code area is an object to be extracted.

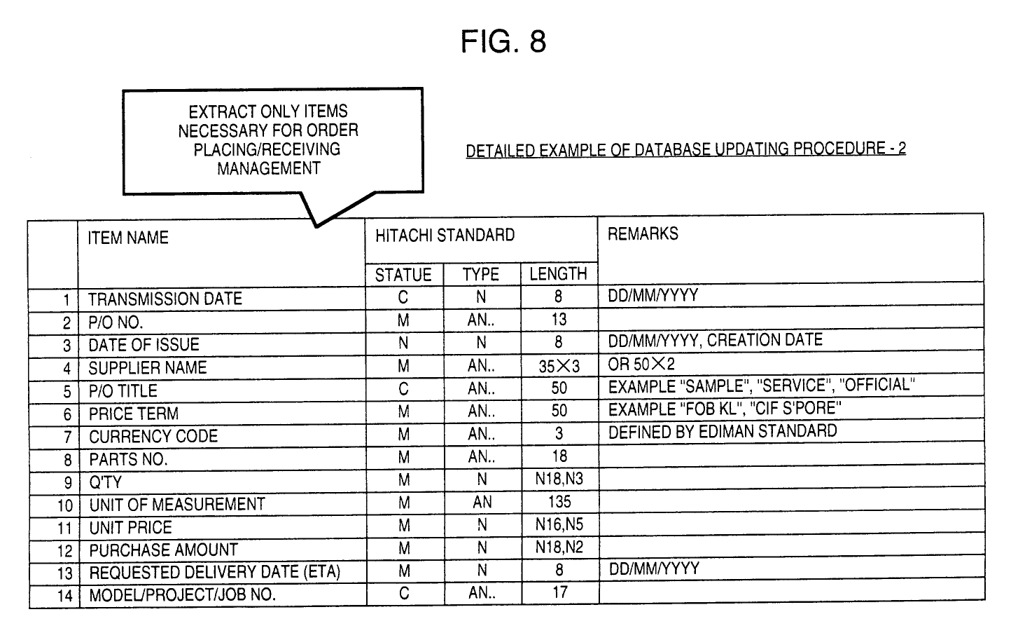

FIG. 8 shows items of data for registration in database, in which only necessary items are extracted in Step 604 from the EDI data of FIG. 7 and other items are excluded. Only items necessary for management of placing and receiving an order are extracted from the items of FIG. 7.

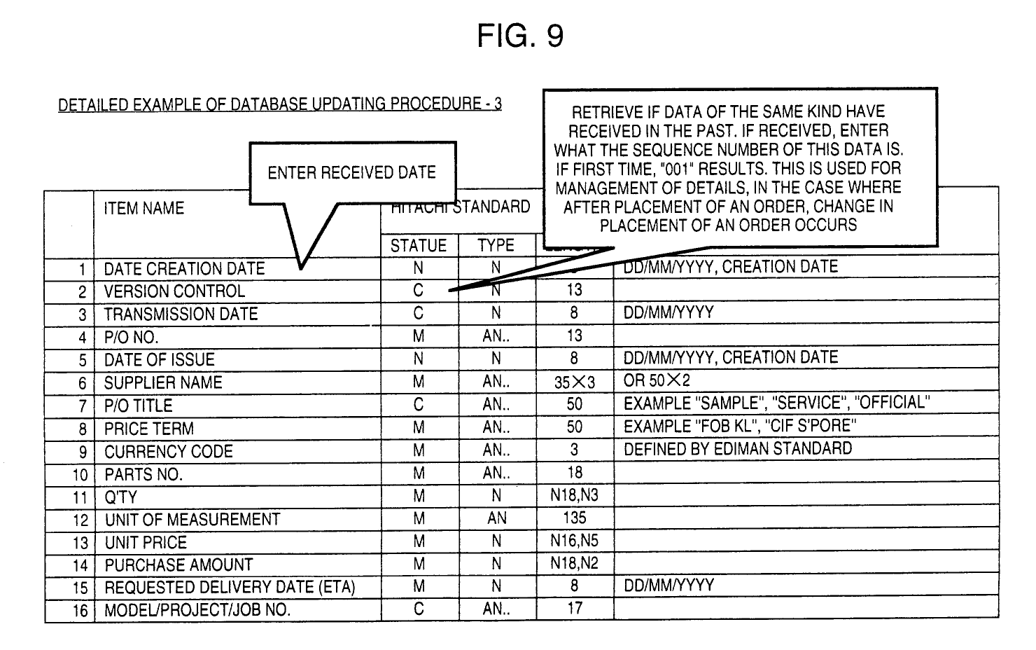

In FIG. 9, a column of Data Creation Date indicated at item number 1 and a column of Version Control (version indicating the sequence number of the data) are further added to the items of FIG. 8. Received date of the EDI data is entered, in Step 605, in the column of Data Creation Date. The value indicative of the sequence number explained in Step 606 is entered in the column of Version Control. The data of the item in FIG. 9 will be data to be registered in the common database in Step 607.

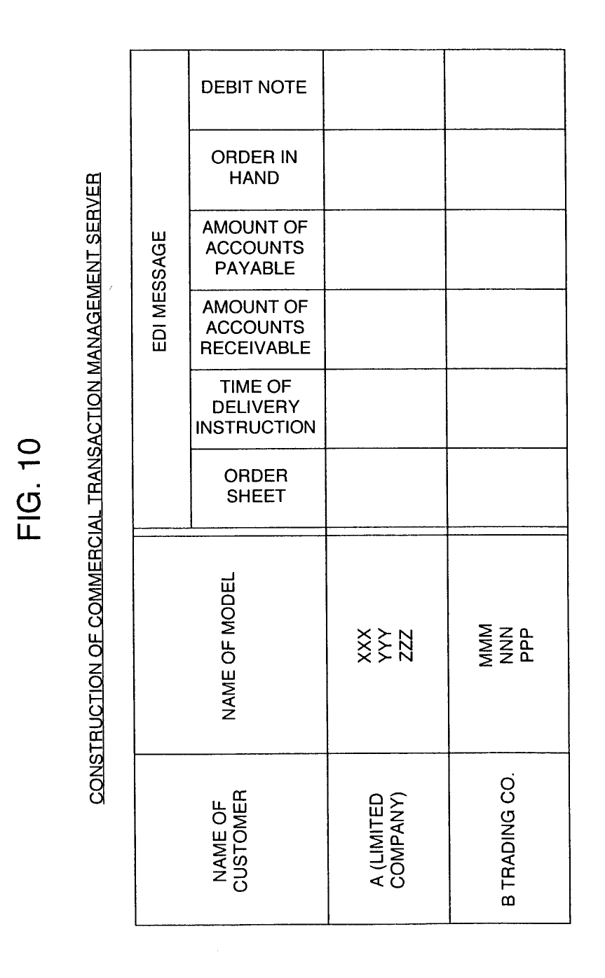

FIG. 10 shows the construction of the aforementioned common database (database of the commercial transaction management). The common database comprises information each customer (for example, each maker in FIG. 2), and information of each customer comprises each EDI message classified for project. FIG. 10 shows an example of storage based on classification of model names for each customer and EDI messages relating to the model (such as an order sheet, a time of delivery instruction, amount of accounts payable, amount of accounts receivable, adebit note, etc.). While in Step 607 of FIG. 6, the extracted EDI data are registered in the common database, it is noted that specifically, the data of item in FIG. 9 is stored in the construction as in FIG. 10.

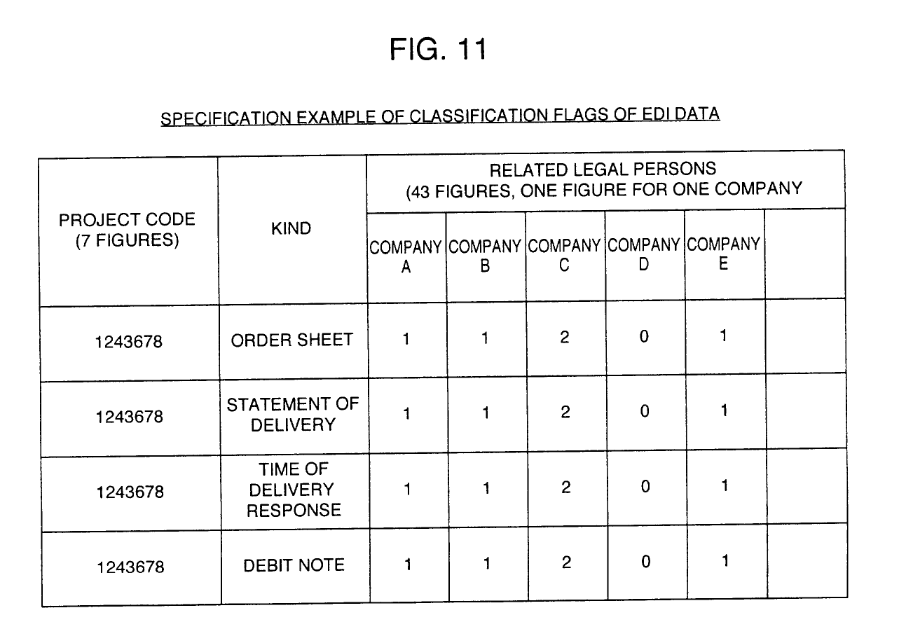

FIG. 11 shows an example of use of a classification flag of EDI data. As described above, the classification flag is a flag for determining if data is an objective data to be registered in a common database. For example, in FIG. 7 example, “P/0 Title” indicated at item number 13 is a classification flag. Data in FIG. 11 is prepared in advance in the commercial transaction management server. In Step 603, checking is made if the “P/0 Title” of the received EDI data is registered in a project code in FIG. 11. If the project code coincides, checking is made if the kind of EDI data coincides with the kind column in FIG. 11. The coincident EDI data is made data to be extracted. EDI data which does not coincide or in which no project code is written is outside the management object and not down-loaded in the server.

Further, the column of related legal persons in FIG. 11 shows what kind of authority each related legal person for each project has with respect to EDI data of the kind described in the kind column. The user defines to which related legal person data is disclosed every project using the table when a message of EDI is prepared. Specifically, in the column of related legal persons in FIG. 11, “0” indicates that the data is not disclosed in the related legal person; “1” indicates that the data is disclosed in the related legal person; and “2” indicates that the data is disclosed in the related legal person and changed.

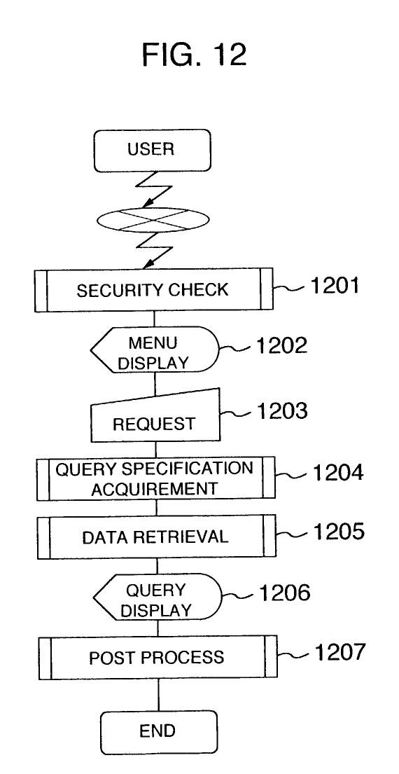

FIG. 12 is a flowchart showing the procedure in which after the EDI message has been registered in the common database in the procedure shown in FIG. 6, the user allows a browser to make access to the common database of the commercial transaction management server via the Internet or intranet. In Step 1201, the identification of the principal of the user who has made access is made based on a user ID and a password. Subsequently, in Step 1202, the range to which the user who has made access can refer is confirmed from the user ID, a menu screen is prepared according to the range to display it.

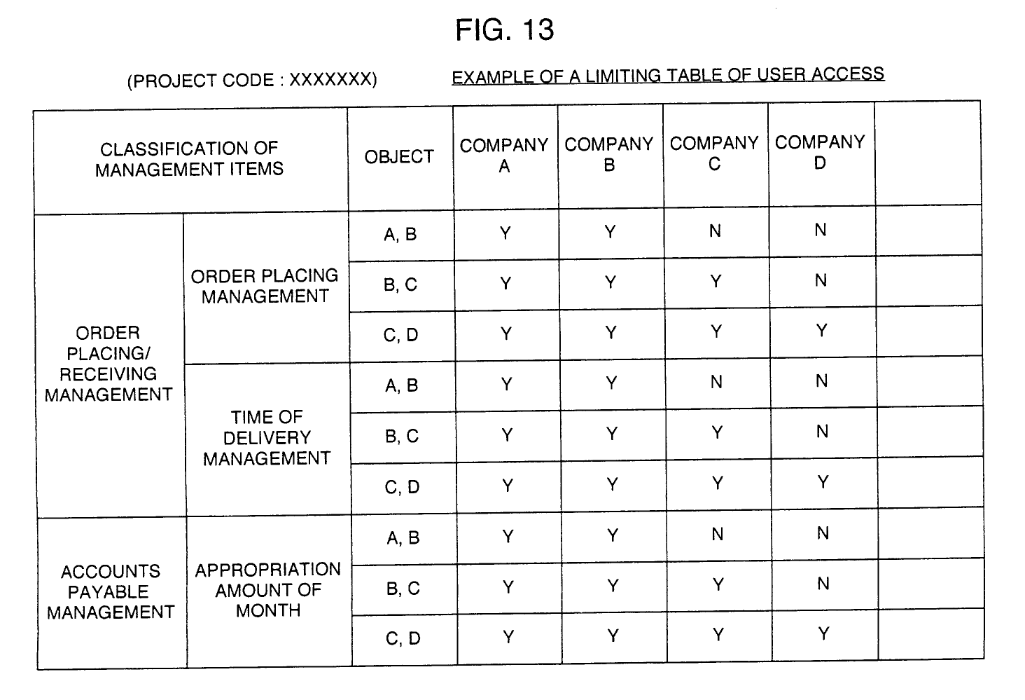

The range to which each user can refer is determined on the basis of an access limiting table as shown in FIG. 13. In the table of FIG. 13, in project codes, a user defines a suitable code with respect to a lump of businesses such as final products, which is indicated by 7 figures “XXXXXXX” here. A classification of management items classifies respective management reports every purposes. The object defines which transaction is an object for respective management report. For example, “A, B” means that transaction between company A and company B is an object. In the table, “Y” represents that reference is possible, and “N” represents that reference is impossible. For example, in an order placing management report for transaction between company A and company B, company A and company B can refer thereto, and company C and company D cannot refer thereto. By the user access limiting table, a related enterprise can monitor the state of transaction according to a degree of participation in production of the model.

Returning again to FIG. 12, in Step 1203, the operation is carried out in which a user requests a necessary management report in accordance with the menu displayed. In Step 1204, a query representative of specification information of the management report requested is obtained. The query defines the conditions inquired with respect to the database.

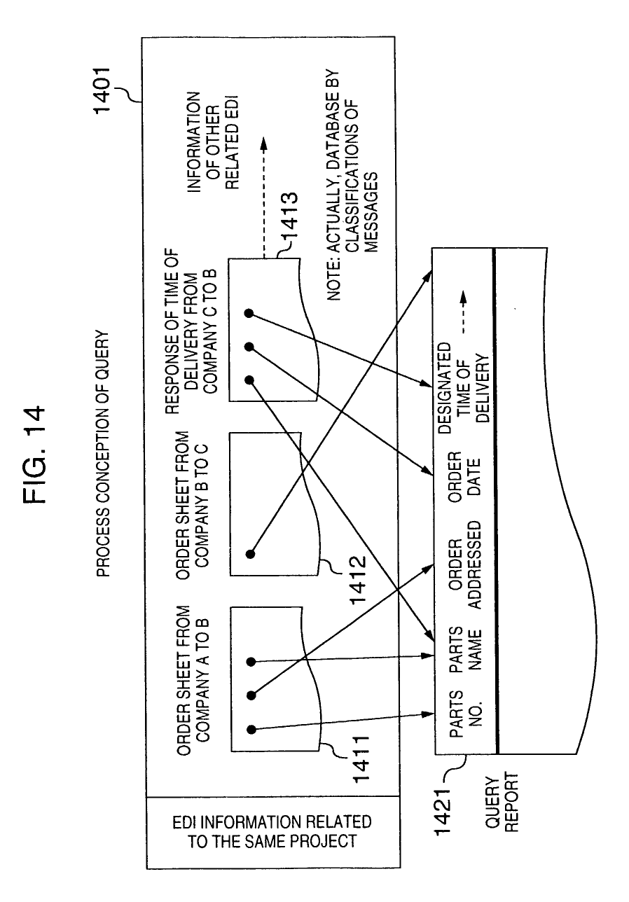

FIG. 14 shows a process conception of the query. In the figure, numeral 1401 designates a common database in which EDI information exchanged between a plurality of parties in connection with the same project are collected. In the common database is stored various EDI data such as order sheets 1411, 1412, the time of delivery response 1413 and the like, as explained in connection with FIG. 6. A query report 1421 is formed in a manner such that only necessary items of necessary messages are extracted using the query to embed them in a predetermined format. Data first referred to by a user is stressed by changing a display color or the like. In the case where old data are changed by EDI data (for example, in the case where the designated time of delivery of the time of delivery instruction data is changed), old data are stored as a background and then updated to new data so as to able to refer to the past according to the need of a user. The query is prepared in advance according to a management report to be displayed and prepared on the server. The association between the EDI data and the query report is different according to the contents of a project, the policy of management or the like.

Returning again to FIG. 12, in Step 1205, data is retrieved from the common database using the acquired query, and in Step 1206, the query report is displayed. At this time, new data may be displayed with a stressing color. Options such as print-out, down-load or the like can be affixed. Further, data on the screen is changed according to the user's authority. In Step 1207, in the case where the user corrects data from the query screen, database is updated. For new data (displayed with a stressing color), a flag is changed to normal display after reference.

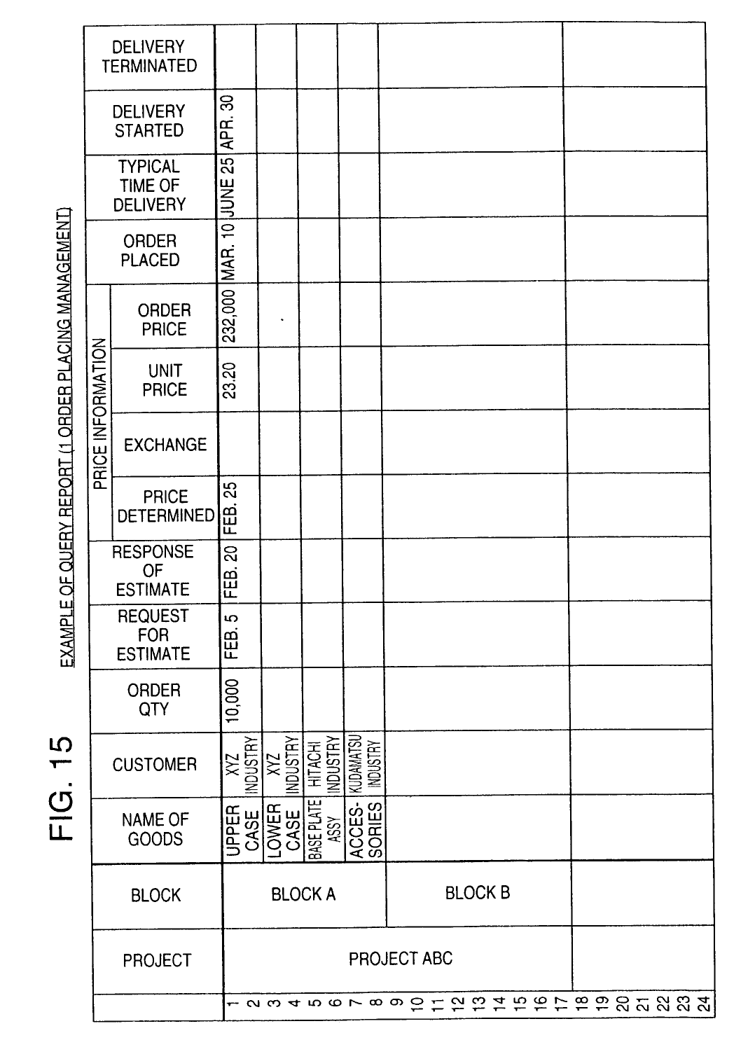

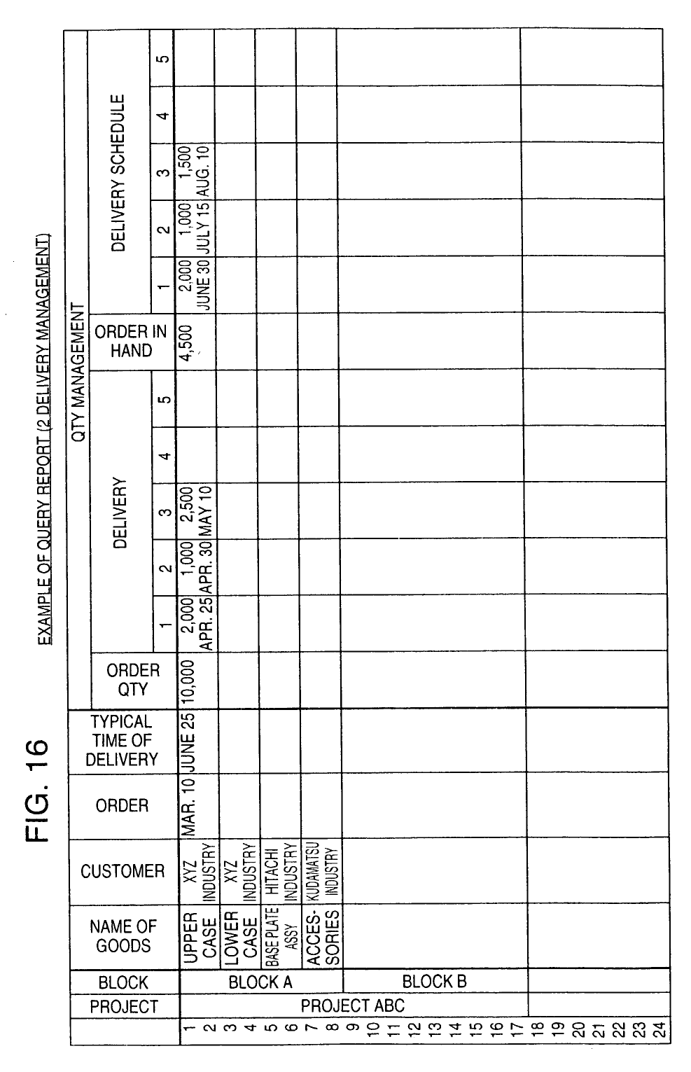

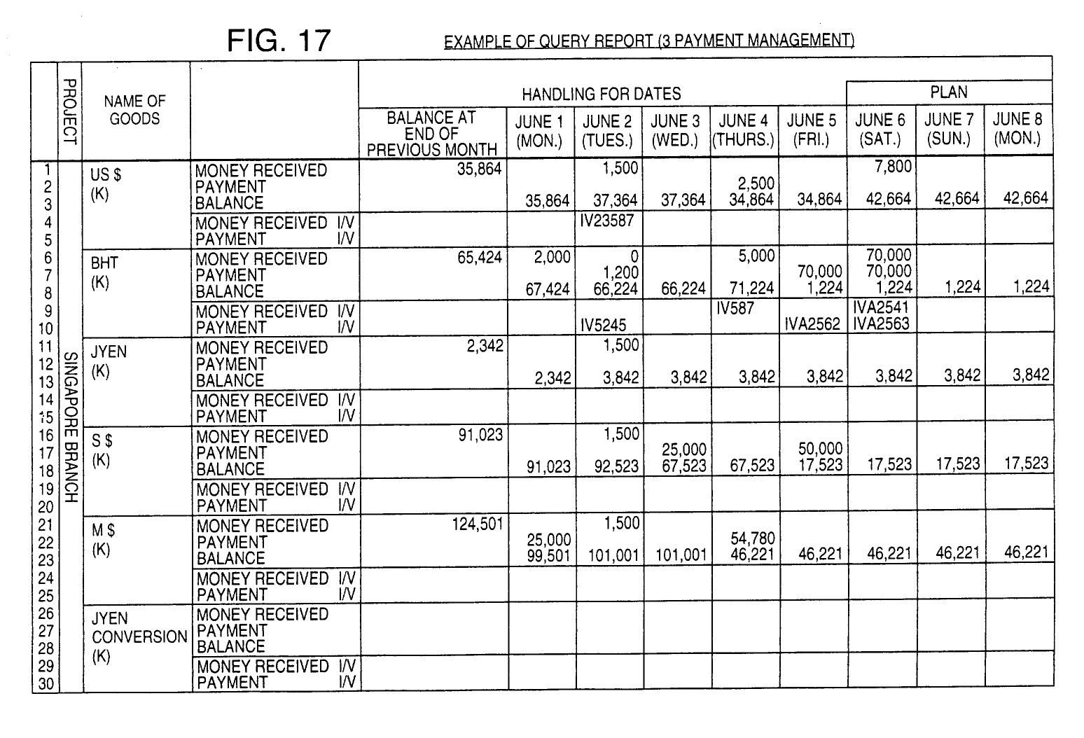

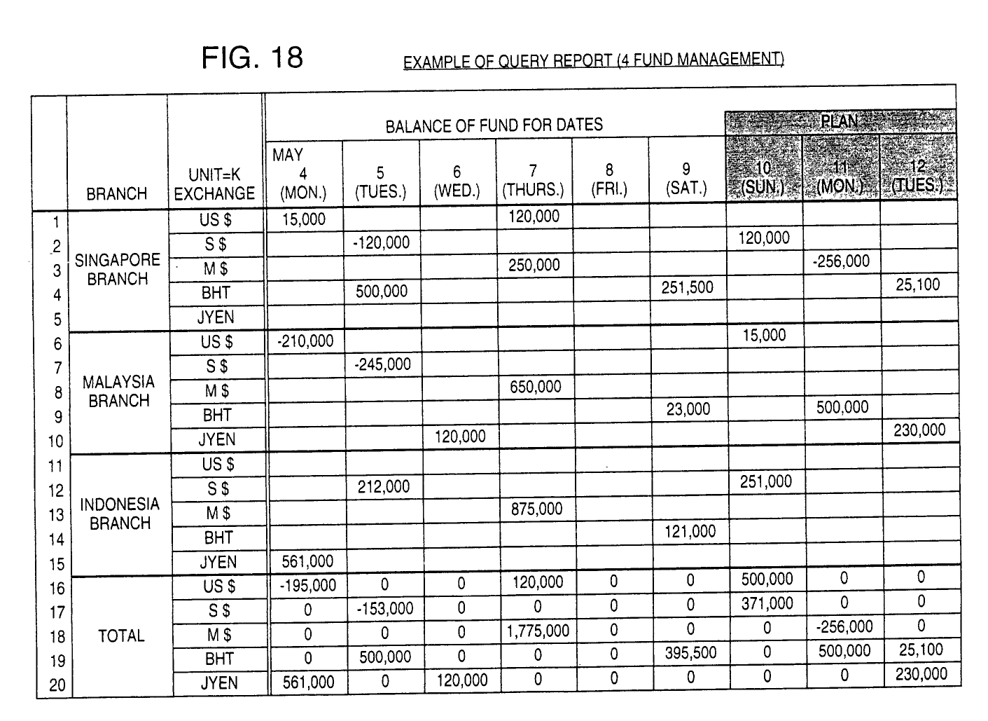

FIGS. 15 to 18 show examples of query reports displayed in Step 1206. FIG. 15 shows aquery report relating to an order placing management, which traces details, with respect to the individual order placing matter, from an estimate and a decision of price to delivery. FIG. 16 shows a report relating to the delivery management, which includes information, with respect to the individual order placing matter, of actual delivery results of divisional delivery, future schedules of delivery and the like. FIG. 17 shows a query report relating to the paying management, which totals paying schedules by exchanges on the basis of debit notes from customers. The query report further displays estimated payments in future on the basis of delivery schedules from customers. FIG. 18 shows a query report relating to the fund management, in which enterprises in overseas total payment information of commercial transaction of the entire points from EDI data to total and manage necessary amounts of funds for the entire company.

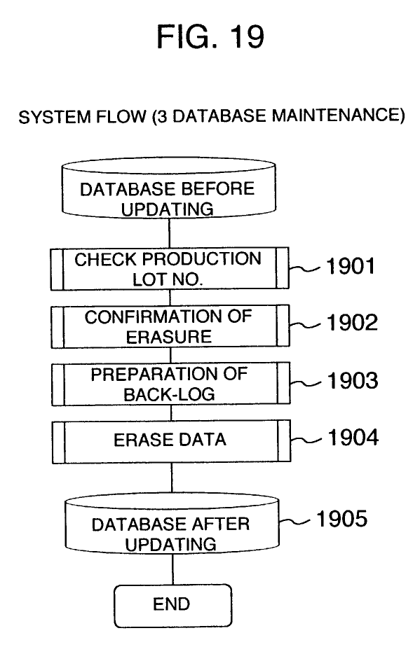

FIG. 19 shows the process procedure for maintenance of common database. As described above, the common database is divided every EDI messages, and respective maintenance can be accomplished. In Step 1901, confirmation is made if production lot numbers of the EDI data for maintenance are completed in production. Subsequently, in Step 1902, confirmation is made if predetermined days have passed after completion of the production lot number of the data. The days are suitably designated by a customer user. In Step 1903, a back-log for data to be erased is prepared. In Step 1904, the data to be erased in data are erased, database is updated, and after updating, database 1905 is obtained.

In the EDI system according to the present invention, the user which accessed to the relational database or the management report can be charged.

The present invention is not limited to the embodiments disclosed. The present invention includes various modifications within the scope and spirit of claims.

What is claimed is:

1. A transaction management system comprising:
means for exchanging EDI data for doing one-on-one transaction between suitable one set of parties out of a plurality of parties entered for said EDI;
means for extracting information relating to a predetermined commercial transaction from said EDI data on a way of a path for transmitting and receiving said EDI data exchanged and registering said information extracted in an external database; and
means for providing data from said database to a user to whom is allowed predetermined access authority out of said plurality of parties to make access to said database.

2. The commercial transaction management system according to claim 1, wherein said means for extracting and registering the information comprises means for building up a database for each of kinds of management information.

3. The commercial transaction management system according to claim 1, wherein said means for extracting and registering the information comprises means for taking out data retrieved under predetermined conditions out of said database and making various management reports relating to commercial transaction between said parties from said data taken out.

4. The commercial transaction management system according to claim 3, wherein said means for providing data comprises means for allowing a person having predetermined authority to refer to said management reports according to a level of said authority.

5. The commercial transaction management system according to claim 1, wherein said means for extracting and registering the information comprises means for updating contents of said database in association with said EDI data of commercial transaction exchanged.

6. The commercial transaction management system according to claim 1, wherein said means for extracting and registering the information comprises means for updating contents of said management reports in association with said EDI data of commercial transaction exchanged.

7. The commercial transaction management system according to claim 1, further comprising means for charging an account a person who makes access to said database.

8. A terminal equipment in a commercial transaction management system, comprising:
means for accessing a database under a management of an EDI provider, said database comprising information relating to a predetermined commercial transaction, said information extracted from EDI data exchanged between a plurality of parties entered for an EDI system; and
means for receiving said information relating to said commercial transaction from said database.

9. A transaction management method, comprising the steps of:
extracting information usable in a commercial transaction management from EDI data exchanged between a plurality of parties entered for an EDI system and making a database; and
providing data from said database to a user to whom is allowed predetermined access authority out of said plurality of parties to make access to said database.

10. The commercial transaction management method according to claim 9, wherein said step of making the database comprises a step of building up a database for each of kinds of management information.

11. The commercial transaction management method according to claim 9, wherein said step of making the database comprises a step of taking out data retrieved under predetermined conditions out of said database and making various management reports relating to commercial transaction between said parties from said data taken out.

12. The commercial transaction management method according to claim 9, wherein said step of providing data comprises a step of allowing a person having predetermined authority to refer to said database according to a level of said authority.

13. The commercial transaction management method according to claim 11, wherein said step of providing data comprises a step of allowing a person having predetermined authority to refer to said management reports according to a level of said authority.

14. The commercial transaction management method according to claim 9, wherein said step of making the database comprises a step of updating contents of said database in association with said EDI data of commercial transaction exchanged.

15. The commercial transaction management method according to claim 11, wherein said step of making the database comprises a step of updating contents of said management reports in association with said EDI data of commercial transaction exchanged.

16. The commercial transaction management method according to claim 9, further comprising a step of charging an account a person who makes access to said database.

17. The commercial transaction management method according to claim 11, further comprising a step of charging an account a person who makes access to said management reports.

18. A commercial transaction management method, comprising the steps of:
accessing a database under a management of EDI provider, said database comprising information relating to a predetermined commercial transaction, said information extracted from EDI data exchanged between a plurality of parties entered for an EDI system; and
receiving said information relating to said commercial transaction from said database.

19. A recording medium recording commercial transaction management data, said recording medium capable of being read by a computer, said commercial transaction management data comprising:
a first recording portion for registering names of a plurality of customers;
a second recording portion for registering one or a plurality of names of models relating to a commercial transaction for each of said names of said customers; and
a third recording portion for storing EDI messages classified according to a kind of an EDI message for each of said names of said customers and each of said names of said models.

20. A recording medium recording commercial transaction management data, said recording medium capable of being read by a computer, said commercial transaction management data comprising:
a first recording portion for storing a plurality of names of kinds of EDI messages classified;
a flag setting portion provided for each kind of said EDI messages classified for setting a flag indicating as to whether or not an EDI message having said flag is extracted and stored in a database; and
a second recording portion provided for each kind of said EDI messages classified for registering a level of access of a user to said EDI messages.
